(19) United States
(12) Patent Application Publication
(10) Pub. No.: US 2010/0276508 A1
(43) Pub. Date: Nov. 4, 2010

(54) COLOR LIGHTING WATER FOUNTAIN

(76) Inventor: Scott M. Davies, Hacienda Heights, CA (US)

Correspondence Address: Myers Andras Sherman LLP, 19900 MacArthur Blvd., Suite 1150, Irvine, CA, 92612, US

(21) Appl. No.: 12/772,742

(22) Filed: May 3, 2010

Related U.S. Application Data
(60) Provisional application No. 61/175,300, filed on May 4, 2009.

(51) Int. Cl. F21S 8/00

(52) U.S. Cl. 239/18

(57) ABSTRACT

The present invention details an LED water fountain comprising a globe coupled between a shaft and a nozzle. The bottom of the globe couples to the top of the shaft while the top of the globe couples to the bottom of the nozzle. An LED ring resides towards the bottom of the globe producing a beautiful color display. Preferably, the globe is translucent or has varying degrees of transparency so the LED ring creates a beautiful lighting effect utilizing multiple colors. The fountain further comprises a stand having a pump therein coupled to the bottom of the shaft. The pump propels water through the shaft, the globe, and out the nozzle to create a beautiful water display. The LED ring is remotely controlled to adjust brightness, select a specific color(s), and change transitions between colors.

### CROSS REFERENCE TO RELATED APPLICATIONS

Pursuant to 35 U.S.C. §119(e), this application claims priority to U.S. Provisional Patent Application Ser. No. 61/175,300 filed May 4, 2009, incorporated herein by reference in its entirety.

### BACKGROUND OF THE INVENTION

1. Field of the Invention

The present invention relates generally to lighting, and in particular, to a system and method for lighting a water fountain by means of color light emitting diodes (LEDs).

2. Description of Related Art

Conventional outdoor water fountains are used to aerate large bodies of water increasing oxygen levels therein as well as slowing algae/bacteria growth. These outdoor fountains typically float on the surface of the water and are powered by portable generators. Moreover, decorative fountains typically employ water cascading across a series of surfaces (e.g., stones, ledges, etc.) to make a soothing sound.

### BRIEF SUMMARY OF THE INVENTION

In one embodiment, the present invention provides an LED water fountain comprising a globe coupled between a shaft and a nozzle. The bottom of the globe couples to the top of the shaft while the top of the globe couples to the bottom of the nozzle. An LED ring is disposed towards the bottom of the globe, producing a color display. Preferably, the globe is translucent or has varying degrees of transparency such that the LED ring creates a lighting effect utilizing multiple colors. The fountain further comprises a stand having a pump therein coupled to the bottom of the shaft. The pump propels water through the shaft, the globe, and out the nozzle to create a water display. The LED ring may be remotely controlled to adjust brightness, select a specific color(s), and change transitions between colors.

The shaft is slidably adjustable ensuring the top end of the entire globe resides above a water line in the fountain. Preferably, the stand is submerged in water such that the wet-rotor pump performs properly. In another embodiment, the stand does not have a pump, but instead couples to an alternative water source (e.g., sprinkler system, water hose, etc.) which directs water through the stand, shaft, globe, and out the nozzle.

In one embodiment, the LED fountain may employ a cord connecting the pump and/or the LED ring to an alternating current (A/C) power source. Alternatively, the LED ring and/or pump may be powered by direct current (D/C), e.g., batteries, from within the fountain.

These and other features, aspects and advantages of the present invention will become understood with reference to the following description, appended claims and accompanying figures.

### BRIEF DESCRIPTION OF THE DRAWINGS

FIG. 1 illustrates a perspective view of an LED water fountain, according to an embodiment of the invention.

FIG. 2 illustrates an alternative perspective view of the LED water fountain, according to an embodiment of the invention.

FIG. 3 illustrates a perspective view of the LED water fountain, according to an embodiment of the invention.

FIG. 4 illustrates an alternative perspective view of the LED water fountain, according to an embodiment of the invention.

FIG. 5 illustrates a side view of the LED water fountain, according to embodiments of the invention.

FIG. 6A illustrates the LED ring, according to an embodiment of the present invention.

FIG. 6B illustrates a baseplate used to hold the LED ring, according to an embodiment of the present invention.

FIG. 6C illustrates the nozzle, according to an embodiment of the present invention.

FIG. 6D illustrates the nozzle coupled atop the globe, the globe coupled atop the baseplate, according to an embodiment of the present invention.

FIG. 6E illustrates a remote control device for controlling the LED ring, according to an embodiment of the present invention.

FIG. 6F illustrates an exploded view of the LED water fountain, according to an embodiment of the present invention.

FIG. 6G illustrates a power cord used to power the fountain, according to an embodiment of the present invention.

FIG. 6H illustrates an alternative nozzle, according to an embodiment of the present invention.

FIG. 6I illustrates another alternative nozzle, according to an embodiment of the present invention.

FIG. 6J illustrates an alternative power cord, according to an embodiment of the present invention.

FIG. 6K illustrates a pump used for propelling water through the LED water fountain, according to an embodiment of the present invention.

FIG. 6L illustrates an alternative view of the pump, according to an embodiment of the present invention.

### DETAILED DESCRIPTION OF THE INVENTION

The following description is made for the purpose of illustrating the general principles of the invention and is not meant to limit the inventive concepts claimed herein. Further, particular features described within can be used in combination with other described features in each of the various possible combinations and permutations. Unless otherwise specifically defined herein, all terms should be given their broadest possible interpretation including meanings implied from the specification as well as meanings understood by those skilled in the art and/or as defined in dictionaries, treatises, etc.

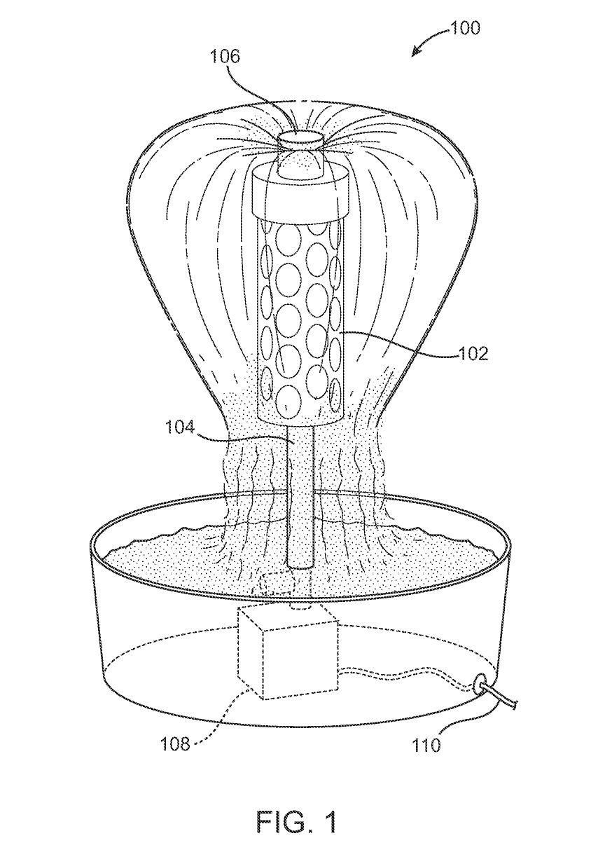

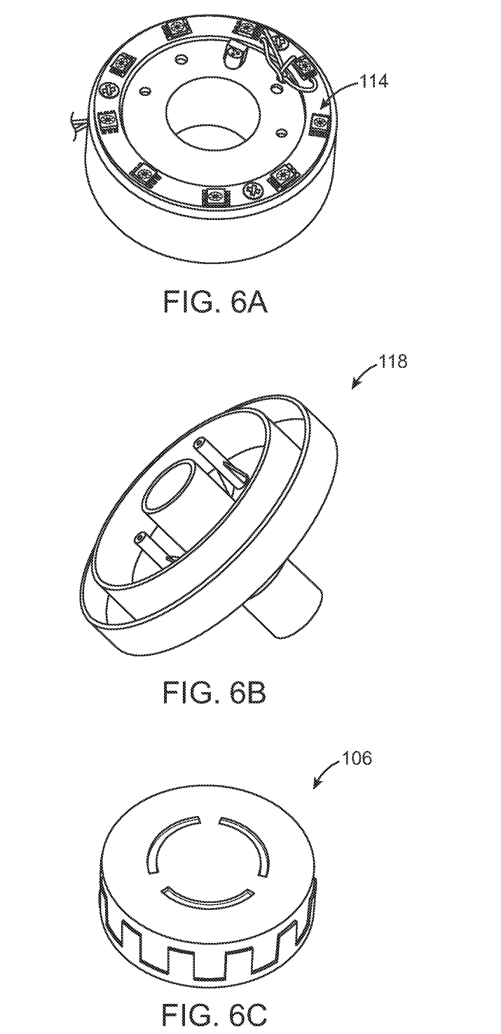

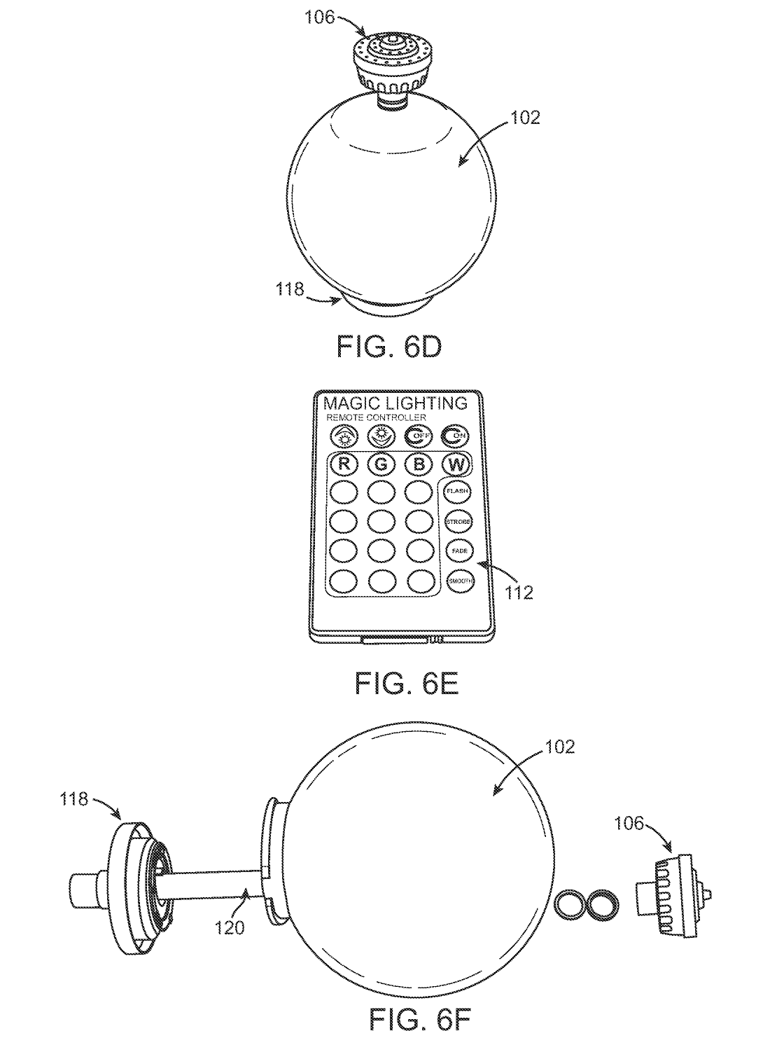

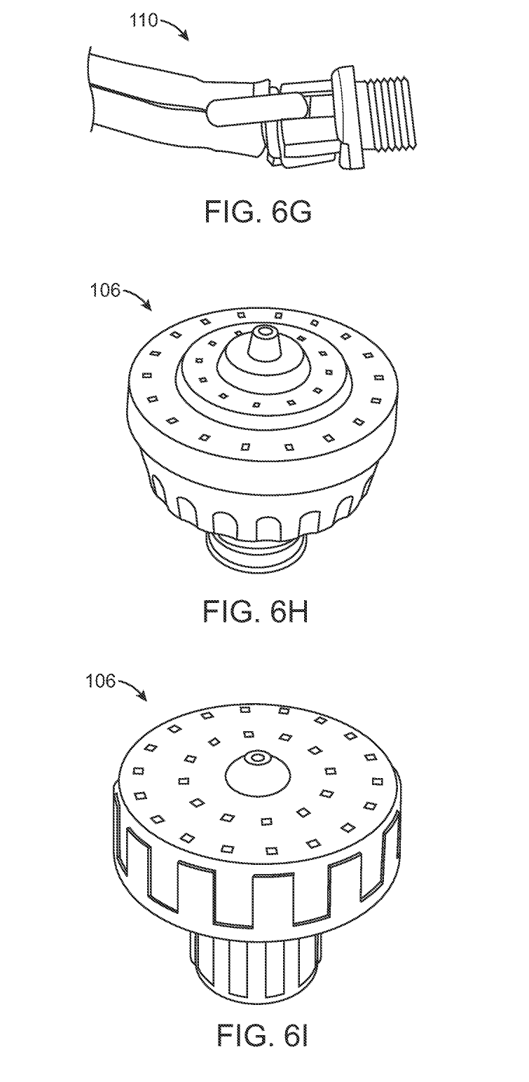

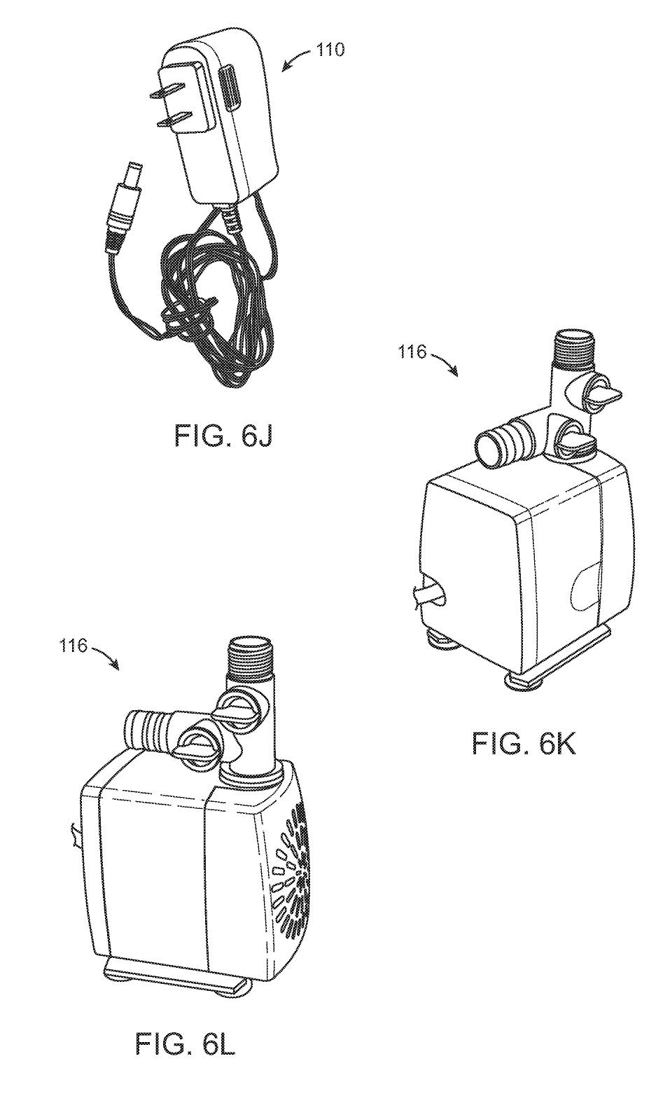

FIG. 1 illustrates a perspective view of an LED water fountain 100, according to an embodiment of the invention. In this embodiment, the fountain 100 comprises an elongated hollow toroid-shaped globe 102 coupled to both a shaft 104 and a nozzle 106. Specifically, the bottom of the globe 102 couples to the top of the shaft 104. The top of the globe 102 couples to the bottom of the nozzle 106. A ring of light emitting diodes (LEDs) 114 (FIG. 6A) resides in the hollow portion of the elongated toroid-shaped globe 102. In one embodiment of the present invention, the LED ring 114 resides towards the bottom of the globe 102. In another embodiment, the LED ring 114 resides towards the top of the globe 102. In yet another embodiment of the present invention, the LED ring 114 resides substantially in the middle of the elongated hollow toroid-shaped globe 102. The hollow globe 102 is constructed such that the LED ring 114 does not contact water flowing through the globe 102. In a preferred embodiment, the elongated hollow toroid-shaped globe 102 is translucent or has varying degrees of transparency so the LED ring 114 creates a beautiful lighting effect.

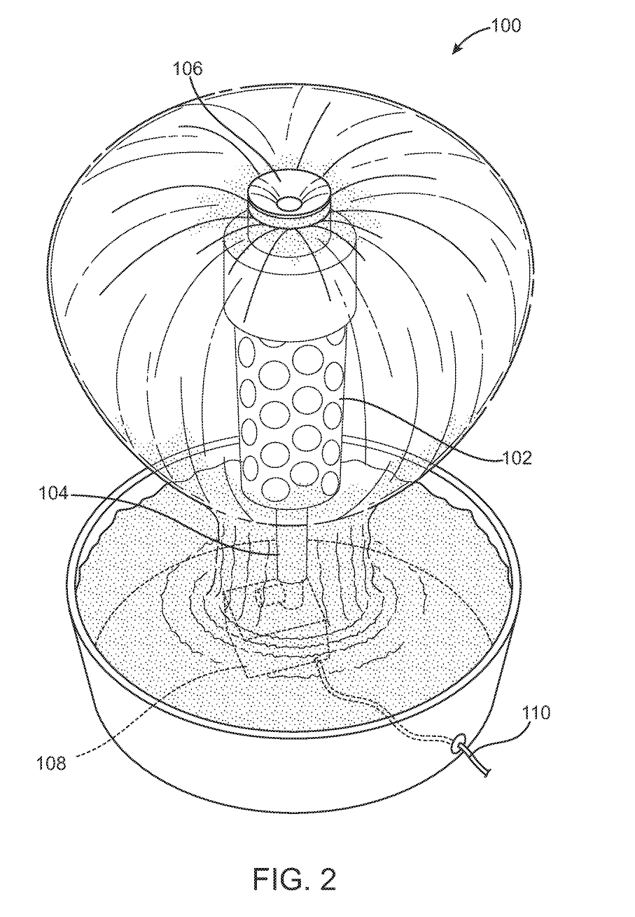

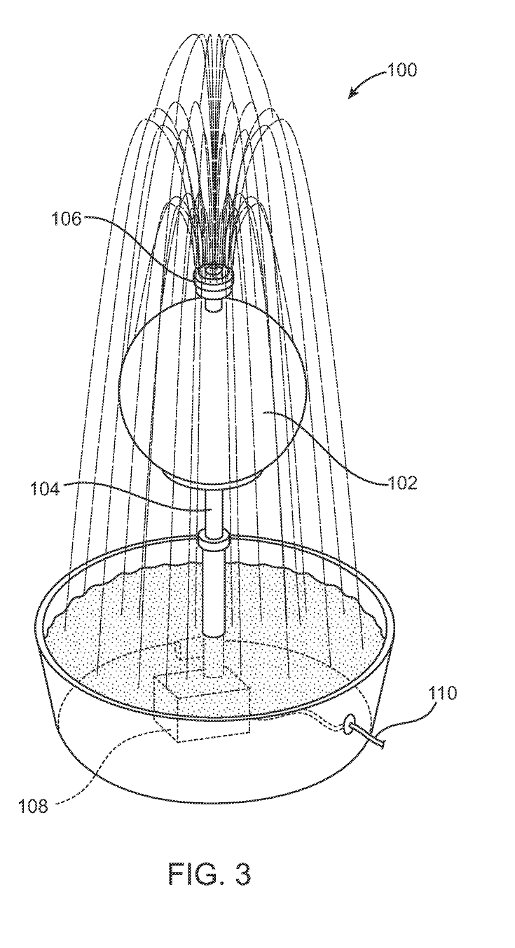

In one embodiment of the present invention, the nozzle 106 couples to the top of the globe 102 by means of a compression coupling. In another embodiment, the nozzle 106 couples to the top of the globe 102 by means of internal threads. The nozzle 106 directs egressing water above the LED fountain 100 to create a plurality of water effects. As exemplified in FIGS. 1-2, the nozzle 106 may direct egressing water to create a bell of water. FIGS. 3-5 demonstrate the nozzle 106 directing egressing water to create a shower effect. Other water effects may include, inter alia, a single vertical column of water, a plurality of vertical water columns, a fan effect, water sprinkles, etc. Different effects may be produced by a single nozzle 106, or interchangeable nozzles (FIGS. 6C, 6H, 6I) from which an end user may select. In all embodiments of the present invention, the nozzle 106 ensures egressing water falls above the globe 102.

With respect to FIG. 2, the shaft 104 comprises a hollow cylinder typically having a diameter smaller than the diameter of the hollow elongated toroid-shaped globe 102. The top of the shaft 104 couples to the bottom end of the globe 102 by means of a compression coupling. In an alternative embodiment of the present invention, the top of the shaft 104 couples to the bottom end of the globe 102 by means of internal threads. In another embodiment of the present invention, the top of the shaft 104 passes through the center of the globe 102 and couples directly to the bottom of the nozzle 106. The bottom of the shaft 104 couples to a stand 108 by means of a compression coupling. In an alternative embodiment, the bottom of the shaft 104 couples to the stand 108 by means of internal threads. The shaft 104 is slidably adjustable ensuring the top end of the shaft 104 and the entire globe 102 reside above a water line. In a preferred embodiment, the shaft 104 adjusts so the globe 102 sits between eight and eighteen inches (8″-18″) above the stand 108.

The stand 108 couples to the bottom of the shaft 104 by means of a compression coupling in FIG. 2. In an alternative embodiment of the present invention, the stand 108 couples to the bottom of the shaft 104 by means of internal threads. In one embodiment, the stand 108 comprises a wet-rotor pump 116 (FIGS. 6K, 6L) residing therein which directs water through the stand 108, shaft 104, globe 102, and out the nozzle 106. Ideally, the stand 108 is submerged in water so the wet-rotor pump 116 performs properly. In another embodiment, the stand 108 does not have a pump 116 residing therein, but instead couples to an alternative water source (e.g., sprinkler system, water hose, etc.) which directs water through the stand 108, shaft 104, globe 102, and out the nozzle 106. In this alternative embodiment, it is not required that the stand 108 be submerged in water.

In one embodiment exemplified in FIG. 2, the LED fountain 100 utilizes a cord 110 to the pump 116 and/or the LED ring 114 to an alternating current (A/C) power source. Alternatively, the fountain 100 may utilize two cords 110 to independently power the pump 116 and LED ring 114. Moreover, the LED ring 114 and/or pump 116 may be powered by use of batteries contained within the LED fountain 100. In a preferred embodiment of the present invention, the pump 116 and LED ring 114 are controlled by use of a multi-function infrared (IR) remote control 112 (FIG. 6E). The remote control 112 is capable of turning the pump 116 on/off, as well as changing the water flow rate. The remote control 112 is also capable of turning on/off the LED ring 114, as well as change the duration between color transitions (e.g., solid color, pulsing single color, strobe, fade colors, etc.). In an alternative embodiment, switches residing on the LED fountain 100 control the LED ring 114 and/or pump 116 functions.

FIG. 2 illustrates an alternative perspective view of the LED water fountain 100, according to an embodiment of the invention. The LED water fountain 100 comprises a hollow elongated toroid-shaped globe 102 coupled to the top of a shaft 104. A nozzle 106 couples to the top of the globe 102 providing for a beautiful display. The bottom of the shaft 104 couples to the stand 108 submerged in water allowing the pump 116 residing therein to direct water through the fountain 100 and egress the nozzle 106. The LED water fountain 100 depicted in FIG. 2 is powered by at least one power cord 110 providing power to the pump 116 inside the stand 108 as well as the LED ring 114 residing within the globe 102.

FIG. 3 illustrates a perspective view of the LED water fountain 100, according to an embodiment of the invention. In this embodiment, the fountain 100 comprises a hollow spheroidal globe 102 coupled to both a shaft 104 and a nozzle 106. The globe 102 comprises an internal hollow cylinder so as water passes through the cylinder it does not contact the inside of the spheroid. Alternatively, the globe is merely hollow without significant internal structure. The bottom of the globe 102 couples to the top of the shaft 104. The top of the globe 102 couples to the bottom of the nozzle 106. A ring of LEDs resides around the internal cylinder 120 (FIG. 6F) in the hollow portion of the spheroid. In an alternative embodiment, the LED ring 114 resides on the outside of the spheroidal globe 102 between the globe and shaft 104. Alternatively, the LED ring 114 may reside between the spheroidal globe 102 and the nozzle 106. In one embodiment of the present invention, the LED ring 114 resides around the internal cylinder 120 towards the bottom of the spheroid. In another embodiment the LED ring 114 resides around the internal cylinder 120 towards the top of the spheroid. In yet another embodiment of the present invention, the LED ring 114 resides around the internal cylinder 120 substantially in the middle of the spheroid. The spheroidal globe 102 is constructed such that the LED ring 114 does not contact water flowing through the internal cylinder 120. In a preferred embodiment, the spheroidal globe 102 is translucent or has varying degrees of transparency so the LED ring 114 creates a beautiful lighting effect.

The bottom of the nozzle 106 couples to the top of the globe 102 by means of a compression coupling. In another embodiment, the bottom of the nozzle 106 couples to the top of the globe 102 by means of internal threads. The nozzle 106 directs egressing water above the LED fountain 100 creating a plurality of water effects. In FIGS. 3-5, a particular nozzle 106 creates a shower water effect instead of the water globe effect created in FIGS. 1-2.

The shaft 104 comprises a hollow cylinder typically having a diameter smaller than the diameter of the hollow spheroidal globe 102. The top of the shaft 104 couples to the bottom end of the globe 102 by means of a compression coupling. In an alternative embodiment of the present invention, the top of the shaft 104 couples to the bottom end of the globe 102 by means of internal threads. In another embodiment of the present invention, the top of the shaft 104 passes through the internal cylinder 120 of the globe 102 and couples directly to the bottom of the nozzle 106. The bottom of the shaft 104 couples to the stand 108 by means of a compression coupling. In an alternative embodiment, the shaft 104 couples to the stand 108 by means of internal threads. The shaft 104 is adjustable ensuring the top end of the shaft 104 and the entire hollow spereoidal globe 102 reside above a water line.

The stand 108 couples to the bottom of the shaft 104 by means of a compression coupling in FIG. 3. In an alternative embodiment of the present invention, the stand 108 couples to the bottom of the shaft 104 by means of internal threads. In one embodiment, the stand 108 comprises a wet-rotor pump 116 residing therein for directing water through the stand 108, shaft 104, globe 102, and out the nozzle 106. Ideally, the stand 108 is submerged in water to ensure the wet-rotor pump 116 performs properly (FIG. 3).

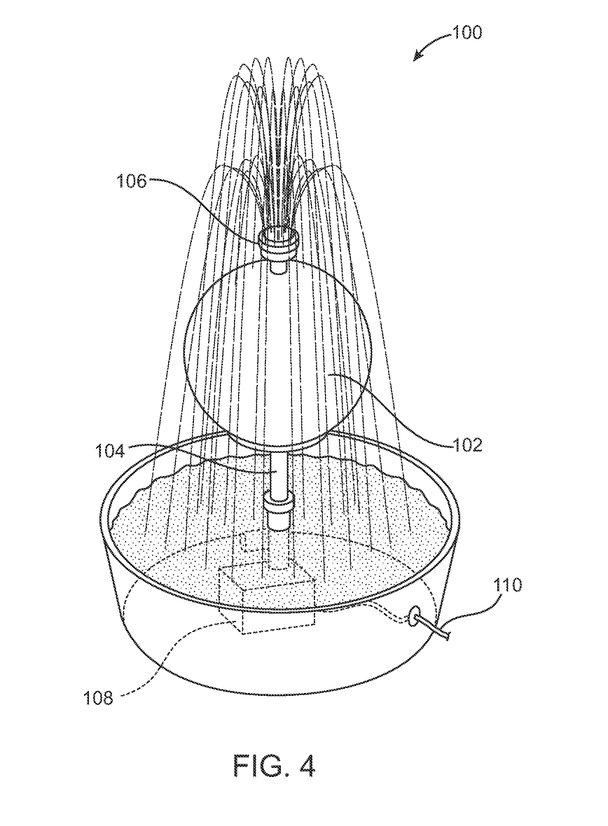

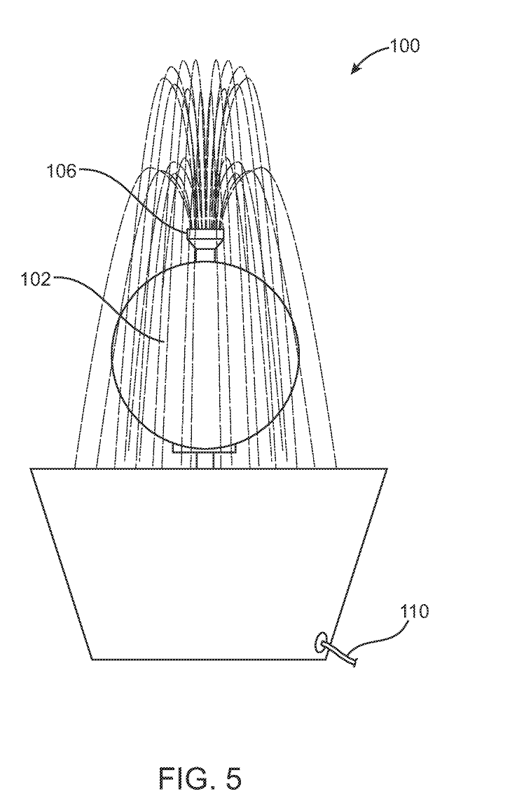

FIGS. 4-5 illustrate alternative perspective views of the LED water fountain 100, according to an embodiment of the invention. In this embodiment, the fountain 100 (FIG. 4) comprises the hollow spheroidal globe 102 coupled to the shaft 104 and nozzle 106 (FIG. 5). The bottom of the shaft 104 and the entire stand 108 are submerged in water (FIG. 4) ensuring proper performance of the wet-rotor pump 116 residing within the stand 108. In this embodiment, the LED water fountain 100 components are powered by a cord 110 from an external power source.

FIGS. 6A-6L illustrate various components of the LED water fountain 100, according to an embodiment of the present invention. FIG. 6A illustrates the LED ring 114, according to an embodiment of the present invention. The LED ring 114 comprises nine light emitting diodes coupled to a metal heatsink.

FIG. 6B illustrates a baseplate 118 used to hold the LED ring 114 (FIG. 6A), according to an embodiment of the present invention. In one embodiment of the present invention, the LED ring 114 and accompanying heatsink (FIG. 6A) reside in the baseplate 118 which couples to the bottom of the globe 102 (FIG. 6D). In this configuration, the globe 102 couples to the baseplate 118 and the base couples to the shaft 104 (FIG. 6D).

FIG. 6C illustrates the nozzle 106, according to an embodiment of the present invention. FIG. 6H illustrates an alternative nozzle 106, according to an embodiment of the present invention. FIG. 6I illustrates another alternative nozzle 106, according to an embodiment of the present invention. The multiple nozzles 106 illustrated in FIGS. 6C, 6H, and 61 are each capable of creating a different water display (e.g., water globe, a single vertical column of water, a plurality of vertical water columns, a fan effect, water sprinkles, tiered streams of water, etc.).

FIG. 6E illustrates a remote control 112 for controlling the LED ring 114 (FIG. 6A), according to an embodiment of the present invention. The remote 112 is capable of turning on/off the LED ring 114 (FIG. 6A), adjusting the brightness of the LED ring 114, select a particular color the LEDs will display, as well as selecting a color transition mode (e.g., flash, strobe, fade, smooth).

FIG. 6F illustrates an exploded view of the LED water fountain 100, according to an embodiment of the present invention. FIG. 6F demonstrates how the nozzle 106 couples to the top of the globe 102. This particular globe 102 is spheroidal in shape and has the internal cylinder 120 contained therein. FIG. 6F illustrates an embodiment where the baseplate 118 is coupled to the globe 102. The baseplate 118 would in turn couple atop the shaft (not shown). The globe 102 may be made of ultra violet (UV) resistant polycarbonate that is translucent or has varying degrees of transparency. Alternatively, the globe 102 may be made of glass. The spheroidal globe 102 in FIG. 6F may have a diameter between four to six inches (4″-6″); whereas the toroidal shaped globe 102 (FIG. 1) may have a length of four to six inches (4″-6″).

FIG. 6K illustrates a pump 116 used for propelling water through the LED water fountain, according to an embodiment of the present invention. FIG. 6L illustrates an alternative view of the pump 116, according to an embodiment of the present invention. In one embodiment of the present invention, the pump 116 is a wet-rotor pump capable of moving at least 130 gallons of water per hour (130 gph) a height of twelve inches (12″). The pump 116 may be powered by alternating current (A/C) which may be supplied by a cord 110 (FIGS. 6G, 6J).

FIG. 6G illustrates a power cord 110 used to power the LED fountain, according to an embodiment of the present invention. FIG. 6J illustrates an alternative power cord 110, according to an embodiment of the present invention. The power cord 110 in FIG. 6G may allow for coupling to the pump 116 (FIGS. 6K, 6L) such that the cord is not submerged in water. However, the alternative power cord 110 in FIG. 6G is waterproof and allows for the pump 116 (FIGS. 6K, 6L) to remain completely submerged.

The present invention has been described in considerable detail with reference to certain preferred versions thereof; however, other versions are possible. Therefore, the spirit and scope of the appended claims should not be limited to the description of the preferred versions contained herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A lighted water fountain, comprising:
a globe element and a shaft member, the globe element including a lighting element, the lighting element comprising a light emitting diode (LED) source, the globe element coupled atop the shaft member having a water inlet; and
a nozzle coupled atop the globe element and adapted to spray water above the fountain, the water being propelled successively through the shaft member, the globe element, and out the nozzle.

2. The fountain of claim 1 further comprising:
a stand having a water inlet, wherein the shaft member is coupled atop the stand.

3. The fountain of claim 2 further comprising:
a pump residing within the stand adapted to propel water from a water source successively through the stand, the shaft member, the globe element, and out the nozzle.

4. The fountain of claim 3 wherein the stand is submerged in a body of water.

5. The fountain of claim 2 wherein the stand couples atop an independent water source which propels water successively through the stand, the shaft member, the globe element, and out the nozzle.

6. The fountain of claim 4 wherein at least a portion of the globe element has an elongated toroid shape.

7. The fountain of claim 4 wherein at least a portion of the globe element has a spheroid shape.

8. The fountain of claim 4 wherein the LED source comprises a ring of plural LEDs residing at the bottom of the globe element.

9. The fountain of claim 4 wherein the LED source comprises a ring of plural LEDs residing at the top of the globe element.

10. The fountain of claim 8 wherein the pump is controlled by a remote control device.

11. The fountain of claim 10 wherein the LED source is controlled by a remote control device.

12. The fountain of claim 11 wherein the pump is powered by alternating current (A/C).

13. The fountain of claim 12 wherein the LED source is powered by alternating current (A/C).

14. The fountain of claim 11 wherein:
the remote control enables adjusting the LED source brightness, selecting colors that the LED source displays, and selecting a transition method between selected colors.

15. A lighted water fountain, comprising:
a globe element and a shaft member, the globe element including a lighting element, the lighting element comprising a light emitting diode (LED) source, the globe element coupled atop the shaft member having a water inlet;
a nozzle coupled atop the globe element and adapted to spray water above the fountain;
a stand having a water inlet, wherein the shaft member is coupled atop the stand; and
a pump residing within the stand adapted to propel water from a water source successively through the stand, the shaft member, the globe element, and out the nozzle.

16. The fountain of claim 15 wherein the pump is powered by direct current (D/C).

17. The fountain of claim 16 wherein the LED source is powered by direct current (D/C).

18. The fountain of claim 17 wherein:
the globe element couples to the shaft member by a compression coupling;
the nozzle couples to the globe element by a compression coupling; and
the shaft member couples to the stand by a compression coupling.

19. The fountain of claim 15 wherein:
the globe element couples to the shaft member by internal threading;
the nozzle couples to the globe element by internal threading; and
the shaft member couples to the stand by internal threading.

20. The fountain of claim 15 wherein the elongated toroid shaped globe element has a length between four and six inches.

21. The fountain of claim 15 wherein the spheroid shaped globe element has a diameter between four and six inches.

22. The fountain of claim 15 wherein the globe element is made of ultraviolet (UV) resistant polycarbonate.

23. The fountain of claim 15 wherein the pump is capable of propelling in one hour at least 130 gallons of water a height of at least 12 inches.

24. A lighted water fountain, comprising:
a globe element and a shaft member, the globe element including a lighting element, the lighting element comprising a light emitting diode (LED) source, the globe element coupled atop the shaft member having a water inlet;
a nozzle coupled atop the globe element and adapted to spray water above the fountain, the water being propelled successively through the shaft member, the globe element, and out the nozzle;
a stand having a water inlet, wherein the shaft member is coupled atop the stand; and
a pump residing within the stand adapted to propel water from a water source successively through the stand, the shaft member, the globe element, and out the nozzle;
wherein the LED source is controlled by a remote control device; and
wherein both the pump and the LED source are powered by alternating current (A/C).
